(19) United States
(12) Patent Application Publication
(10) Pub. No.: US 2020/0257971 A1
(43) Pub. Date: Aug. 13, 2020

(54) FULL-LINEAR MODEL FOR OPTIMAL POWER FLOW OF INTEGRATED POWER AND NATURAL-GAS SYSTEM BASED ON DEEP LEARNING METHODS

(71) Applicant: Chongqing University, Chongqing (CN)

(72) Inventors: Zhifang Yang, Chongqing (CN); Lin Guo, Chongqing (CN); Juan Yu, Chongqing (CN); Wei Dai, Chongqing (CN); Yan Yang, Chongqing (CN); Mingxu Xiang, Chongqing (CN)

(21) Appl. No.: 16/442,462

(22) Filed: Jun. 15, 2019

(30) Foreign Application Priority Data
Feb. 12, 2019 (CN) 201910027181.X

(51) Int. Cl. G06N 3/08; G06F 17/50

(52) U.S. Cl. CPC G06N 3/08; G06F 2217/16; G06F 17/5009

(57) ABSTRACT

Embodiments provide a full-linear model for the optimal power flow of an integrated power and natural-gas system based on a deep learning method, mainly comprising following steps of: 1) establishing an integrated power and natural-gas system and acquiring basic data of the integrated power and natural-gas system; 2) establishing a linear natural-gas model based on deep learning; and 3) based on the linear natural-gas model, establishing a full-linear model for the optimal power flow of the integrated power and natural-gas system. In the full-linear model for the optimal power flow of an integrated power and natural-gas system based on a deep learning method provided by the present invention, one-segment linearization is performed on a natural-gas pipeline model. Compared with the conventional segmented linear model, the method provided by the present invention can greatly improve the calculation efficiency.

### CROSS-REFERENCES TO RELATED APPLICATIONS

This application claims priority to a Chinese patent application No. 201910027181.X filed on Feb. 12, 2019 and entitled “FULL-LINEAR MODEL FOR OPTIMAL POWER FLOW OF INTEGRATED POWER AND NATURAL-GAS SYSTEM BASED ON DEEP LEARNING METHODS”, the disclosure of which is incorporated herein by reference in its entirety.

### TECHNICAL FIELD

The present invention relates to the technical field of economic and optimized calculation of power systems, and in particular to a full-linear model for the optimal power flow of an integrated power and natural-gas system based on a deep learning method.

### BACKGROUND ART

With the increasingly enhanced coupling between a power system and a natural-gas system, the economic and optimized operation of the multi-energy system has become a major research issue. The calculation of the Optimal Power Flow (OPF) is very important to facilitate the safe and economic operation of the multi-energy system. Meanwhile, the OPF plays an important role in reliability analysis, energy management and pricing. The improvements to OPF solvers can save billions of dollars for the multi-energy system every year. However, the non-linearity of an energy flow model determines the non-convexity of an OPF model. As a result, it is difficult to solve the OPF of the multi-energy system. Existing nonlinear solvers cannot ensure the convergence or global optimality of the OPF.

In actual power systems, for example, day-ahead and real-time scheduling, the convergence and calculation efficiency can be ensured only if the OPF model is a convex model. Generally, the convergence of the OPF can be ensured by two basic methods: 1) convex relaxation; and, 2) energy flow model linearization. In the convex relaxation, some parts of the energy flow model can be converted into an inequation from an equation. Under certain conditions, the convex relaxation has a provable optimal close clearance; and in some cases, the globally optimal solution can be obtained. However, if the precondition is not satisfied, it is difficult to reconstruct a new feasible region by the convex relaxation. By contrast, the energy flow model linearization is widely used in industries, particularly in power systems. The linear OPF model can ensure the convergence and be convenient for pricing. The OPF method for DC power flow, as an ideal approximation of the power flow model, verifies a quasi-linear relationship between P and 0, and is widely applied in most power industries. However, in a natural-gas system, unlike the power flow model of a power system with “single-segment” linear approximation, linear power flow models are usually constructed by piecewise linearization. The key difference between the power flow model linearization of the power system and the power flow linearization of the natural-gas system lies in the difference in the range of state variables: the difference in voltage angle between two ends of a branch in the power system is small (generally less than 0.5 radians or 30 degrees); while the pressure difference between two ends of natural-gas pipelines may be much larger (up to 530000 psi2). Therefore, in the conventional natural-gas linearization methods, a state variable has to be divided into multiple segments in order to control the linearization error. However, the increase in the number of linearization segments will result in the increase in the number of integral variables in the OPF model, leading to considerable calculation burdens.

### SUMMARY OF THE INVENTION

An objective of the present invention is to solve the problems in the prior art. To achieve the above objective, the present invention employs the following technical solutions. A full-linear model for the optimal power flow of an integrated power and natural-gas system based on a deep learning method is provided, mainly including the following steps:

1) The integrated power and natural-gas system is established, and basic data of the integrated power and natural-gas system is acquired.
The basic data of the integrated power and natural-gas system is an electrical load and a gas load of the integrated power and natural-gas system.
2) A linear natural-gas model based on deep learning is established.

The establishing a linear natural-gas model based on deep learning mainly includes following steps.

2.1) A nonlinear natural-gas flow model is established, i.e.:

Fₘₙ=sₘₙKₘₙ\sqrt{sₘₙt} (1)

where Fₘₙ^{L} is the flow of a natural-gas pipeline from a node m to a node n, Kₘₙ is a Weymouth coefficient for a pipeline in a steady state, πₘ and πₙ are pressures at the node m and the node n, respectively, sₘₙ is a sign function, and t is a pressure difference between two ends of the natural-gas pipeline.

The value of the sign function sₘₙ is expressed by:

$${s}_{mn} = \{ \begin{matrix}+ 1 & {π}_{m} \geq {π}_{n} \\ - 1 & {π}_{m} < {π}_{n}\end{matrix} . \qquad ( 2 )$$

The pressure difference t between two ends of the natural-gas pipeline is expressed by:

t=(πₘ²πₙ²) (3)

2.2) A deep neural network, i.e., a Stacked Denoising Automatic Encoder (SDAE), is established.

The SDAE is formed by stacking n Denoising Automatic Encoders (DAEs) layer by layer.

An input layer of the l^{th} DAE is denoted by Yₗ₋₁, an intermediate layer is denoted by Yₗ, and an output layer is denoted by Zₗ.

The intermediate layer Yₗ is expressed by:

Yₗ=ƒ_{θ}^{l}(Yₗ₋₁)=R(WₗYₗ₋₁+bₗ) (4)

where ƒ_{θ}^{l}(Yₗ₋₁) represents an encoding function, R is an activation function, θ is an encoding parameter and θ={Wₗ, bₗ}, W is the weight of the encoding function, and bₗ is the bias of the encoding function.

The activation function R is expressed by:

$$R ( x ) = \{ \begin{matrix}x & if x > 0 \\ 0 & if x \leq 0\end{matrix} \qquad ( 5 )$$

where x is the input of a neuron, i.e., load data of the integrated power and natural-gas system.
The output layer Zₗ is expressed by:

Zₗ=g_{θ′}^{l}(Yₗ)=R(Wₗ^{′}Yₗ+bₗ^{′}) (6)

where g_{θ′}^{l} (Yₗ) represents a decoding function, θ′ is a decoding parameter, θ′={Wₗ^{′}, bₗ^{′}}, Wₗ^{′} is the weight of the decoding function, and bₗ^{′} is the bias of the decoding function.
2.3) The electrical load and the gas load are input into the SDAE to obtain an output t.
2.4) The output t is adjusted by unsupervised pre-training and supervised fine-tuning to obtain a predicted result t* of deep learning.
2.5) Based on the predicted result t*, a linear interval [tₘᵢₙ, tₘₐₓ] is selected.

The selecting a linear interval [tₘᵢₙ, tₘₐₓ] mainly includes following steps.

2.5.1) A minimum linear interval tₘᵢₙ is calculated, i.e.:

tₘᵢₙ=c₁t* (7)

where c₁ is a constant, and c₁<1.

tₘₐₓ=c₂t* (8).

2.5.2) A maximum linear interval tₘₐₓ is calculated, i.e.:
where c₂ is a constant, and c₂>1.
2.6) The linear natural-gas model based on deep learning is expressed by:

Fₘₙ^{L}=Kₘₙ(kₘₙt+bₘₙ),tₘᵢₙ≤t≤tₘₐₓ (9)

where Fₘₙ^{L} is the flow of a natural-gas pipeline from a node m to a node n, tₘᵢₙ and tₘₐₓ are minimum and maximum linear intervals, respectively, kₘₙ is a slope, and bₘₙ is an intercept.
The slope kₘₙ is expressed by:

kₘₙ=(\sqrt{tₘₐₓ}−\sqrt{tₘᵢₙ})/(tₘₐₓ−tₘᵢₙ) (10)

where tₘᵢₙ is the minimum linear interval, and tₘₐₓ is the maximum linear interval.

The intercept bₘₙ is expressed by:

bₘₙ=(tₘₐₓ\sqrt{tₘᵢₙ}−tₘᵢₙ\sqrt{tₘₐₓ})/(tₘₐₓ−tₘᵢₙ) (11).

3) Based on the linear natural-gas model, a full-linear model for the optimal power flow of the integrated power and natural-gas system is established.
The establishing a full-linear model for the optimal power flow of the integrated power and natural-gas system mainly includes following steps.
3.1) A target function is established, i.e.:

min ƒ=ΣC_{ep,i}P_{G,i}+ΣC_{gp,i}F_{G,m}+ΣM(εᵣ⁻+εᵣ⁺) (12)

where C_{ep,i} is the unit price of power, C_{gp,i} is the unit price of natural-gas, M is a penalty factor, εᵣ⁻ and εᵣ⁺ are balance variables, the subscript r represents the number of natural-gas pipelines in the network, min ƒ is a minimum total energy cost, the total energy cost including cost of power and cost of natural-gas, P_{G,i} is an active output of a non-gas generator set, and F_{G,m} is the injection amount from a gas source.
3.2) Constraints are set, mainly including following steps.
2.1) Constraints for a power system are set, mainly including an electric power balance constraint, an active power constraint for a gas generator set, an active power constraint for a non-gas generator set and a power transmission line constraint.

The electric power balance constraint is expressed by:

P_{G,i}+P_{GAS,i}−P_{D,i}−(θᵢ−θⱼ)/xᵢⱼ=0,i=1,2, . . . ,Nₑ (13)

where P_{G,i} is an active output of a non-gas generator set, P_{D,i} is an active load, θᵢ is the voltage phase angle of a node i, θⱼ is the voltage phase angle of a node j, xᵢⱼ is the reactance of branches, and Nₑ is the number of nodes in the power system.

The active power constraint for the gas generator set is expressed by:

P_{GAS,i}^{min}≤P_{GAS,i}≤P_{GAS,i}^{max},i=1,2, . . . ,Nₑ (14)

where P_{GAS,i}^{min} is a minimum active output of the gas generator set, and P_{GAS,i}^{max} is a maximum active output of the gas generator set.

The active power constraint for the non-gas generator set is expressed by:

P_{G,i}^{min}≤P_{G,i}≤P_{G,i}^{max},i=1,2, . . . ,Nₑ (15)

where P_{G,i}^{min} is a minimum active output of the non-gas generator set, and P_{G,i}^{max} is a maximum active output of the non-gas generator set.

The power transmission line constraint is expressed by:

−Tₗ^{min}≤B_{ƒ}(θᵢ−θⱼ)≤Tₗ^{max},l=1,2, . . . ,Nᵣ (16)

where B_{ƒ} is a matrix for calculating a transmitted power vector of branches, Tₗ^{min} and Tₗ^{max} are minimum and maximum transmitted power of the branches, respectively, and Nᵣ is the number of branches.
3.2.2) Constraints for a natural-gas system are set, mainly including a gas flow balance constraint, a constraint for the pressure difference t between two ends of the natural-gas pipeline, a gas source constraint, a node pressure constraint and a compressor constraint.

The gas flow balance constraint is expressed by:

F_{G,m}−F_{GAS,m}−F_{D,m}−Fₘₙ^{L}=0,m=1,2, . . . ,Nₘ (17)

where F_{GAS,m} is the consumption of natural-gas by the gas generator set, F_{D,m} is a gas load, and Nₘ is the number of natural-gas nodes.

The pressure difference t between two ends of the natural-gas pipeline is expressed by:

tₘ^{min}−εᵣ⁻≤tₘ≤tₘ^{max}+εᵣ⁺,m=1,2, . . . ,Nₘ (18).

The gas source constraint is expressed by:

F_{G,m}^{min}≤F_{G,m}≤F_{G,m}^{max},m=1,2, . . . ,Nₘ (19)

where F_{G,m}^{min} is a minimum injection amount from the gas source, and F_{G,m}^{max} is a maximum injection amount from the gas source.
The node pressure constraint is expressed by:

πₘ^{min}≤πₘ≤πₘ^{max},m=1,2, . . . ,Nₘ (20)

where πₘ^{min} is a minimum pressure at a node m, and πₘ^{max} is a maximum pressure at the node m.
The compressor constraint is expressed by:

πₙ≤Γ_{c}·πₘ,m=1,2, . . . ,Nₘ (21)

Γ_{c} is the compression ratio of a compressor.
3.2.3) Constraints for a coupling element are set, i.e.:

F_{GAS,h}=P_{GAS,h}/(η_{GAS,h}GHV),h=1,2, . . . ,N_{b} (22)

where η_{GAS,h} is the conversion efficiency of the gas generator set, GHV is a high heat value, and N_{b} is the number of gas generator sets.

The technical effects of the present invention are undoubted. In the full-linear model for the optimal power flow of an integrated power and natural-gas system based on a deep learning method in the present invention, one-segment linearization is performed on a natural-gas pipelines model. Compared with the conventional segmented linear model, the method provided by the present invention can greatly improve the calculation efficiency.

### THE DESCRIPTION OF DRAWINGS

FIG. 1 shows a diagram of a conventional gas segmented linear model;

FIG. 2 shows a one-segment linear model for natural-gas pipelines based on a full-linear model for the OPF of an integrated power and natural-gas system based on a deep learning method;

FIG. 3 shows a logical structure diagram of an SDAE;

FIG. 4 shows a typical loop network in a natural-gas network;

FIG. 5 shows a typical tree network in a natural-gas network;

FIG. 6 shows a network graph of a 14 NGS nodes;

FIG. 7 shows a network graph of 10 NGS nodes;

FIG. 8 shows the comparison, in terms of the value of t, of a conventional natural-gas segmented linearization and a one-segment linear model based on the full-linear model for the OPF of the integrated power and natural-gas system; and

FIG. 9 shows normalized natural-gas pipeline flow of models M1 and M2.

### DETAILED DESCRIPTION OF THE PREFERRED EMBODIMENT

The present invention will be further described below by embodiments, but it should be understood that the scope of the subject of the present invention is not merely limited to the following embodiments. Various replacements and alterations made according to the general technical knowledge and conventional means in the art without departing from the technical concept of the present invention shall fall into the protection scope of the present invention.

### Embodiment 1

A full-linear model for the optimal power flow of an integrated power and natural-gas system based on a deep learning method is provided, mainly including following steps.

1) The integrated power and natural-gas system is established, and basic data of the integrated power and natural-gas system is acquired.

The basic data of the integrated power and natural-gas system is an electrical load and a gas load of the integrated power and natural-gas system.

2) A linear natural-gas model based on deep learning is established.

The establishing a linear natural-gas model based on deep learning mainly includes following steps.

2.1) A nonlinear natural-gas flow model is established, i.e.:

Fₘₙ=sₘₙKₘₙ\sqrt{sₘₙt} (1)

where Fₘₙ^{L} is the flow of a natural-gas pipeline from a node m to a node n, Kₘₙ is a Weymouth coefficient for a pipeline in a steady state, πₘ and πₙ are pressures at the node m and the node n, respectively, sₘₙ is a sign function, and t is a pressure difference between two ends of the natural natural-gas pipeline.

The value of the sign function sₘₙ is expressed by:

$${s}_{mn} = \{ \begin{matrix}+ 1 & {π}_{m} \geq {π}_{n} \\ - 1 & {π}_{m} < {π}_{n}\end{matrix} . \qquad ( 2 )$$

The pressure difference t between two ends of the natural-gas pipeline is expressed by:

t=(πₘ²−πₙ²) (3)

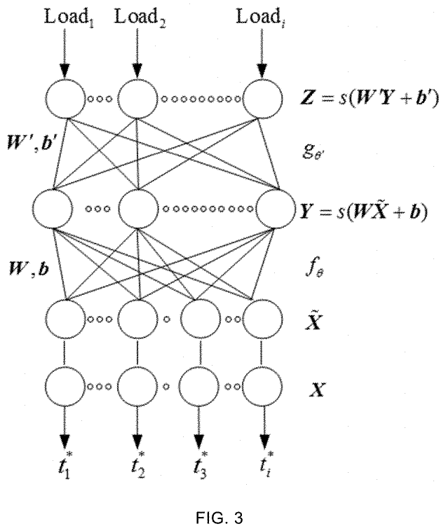

2.2) A deep neural network, i.e., a Stacked Denoising Automatic Encoder (SDAE), is established, as shown in FIG. 3.

The SDAE is formed by stacking n Denoising Automatic Encoders (DAEs) layer by layer.

An input layer of the l^{th} DAE is denoted by Yₗ₋₁, an intermediate layer is denoted by Yₗ, and an output layer is denoted by Zₗ.
The intermediate layer Yₗ is expressed by:

Yₗ=ƒ_{θ}^{l}(Yₗ₋₁)=R(WₗYₗ₋₁+bₗ) (4)

where ƒ_{θ}^{l}(Yₗ₋₁) represents an encoding function, R is an activation function, θ is an encoding parameter and θ={Wₗ, bₗ}, Wₗ is the weight of the encoding function, and bₗ is the bias of the encoding function.

The activation function R is expressed by:

$$R ( x ) = \{ \begin{matrix}x & if x > 0 \\ 0 & if x \leq 0\end{matrix} \qquad ( 5 )$$

where x is the input of a neuron, i.e., load data of the integrated power and natural-gas system.

The output layer Zₗ is expressed by:

Zₗ=g_{θ′}^{l}(Yₗ)=R(Wₗ^{′}Yₗ+bₗ^{′}) (6)

where g_{θ′}^{l} (Y) represents a decoding function, θ′ is a decoding parameter, θ′={Wₗ^{′}, bₗ^{′}}, Wₗ^{′} is the weight of the decoding function, and bₗ^{′} is the bias of the decoding function.
2.3) The electrical load and the gas load are input into the SDAE to obtain an output t.
2.4) The output t is adjusted by unsupervised pre-training and supervised fine-tuning to obtain a predicted result t* of deep learning.
1) Unsupervised pre-training is performed on the SDAE, and a set of the encoding parameter θ and the decoding parameter θ′ is selected to minimize the calculation parameter M.
The calculation parameter M is expressed by:

M=∥Yₗ₋₁−g_{θ′}^{l}(ƒ_{θ}^{l}(Yₗ₋₁))∥² (7).

2) Supervised fine-tuning is performed on the SDAE, that is, optimized selection is further performed on the encoding parameter θ.
2.5) Based on the predicted result t*, a linear interval [tₘᵢₙ, tₘₐₓ] is selected.

The selecting a linear interval [tₘᵢₙ, tₘₐₓ] mainly includes following steps.

2.5.1) A minimum linear interval tₘᵢₙ is calculated, i.e.:

tₘᵢₙ=c₁t* (8)

where c₁ is a constant, and c₁<1.

tₘₐₓ=c₂t* (9).

2.5.2) A maximum linear interval tₘₐₓ is calculated, i.e.:
where c₂ is a constant, and c₂>1.
2.6) The linear natural-gas model based on deep learning is expressed by:

Fₘₙ^{L}=Kₘₙ(kₘₙt+bₘₙ),tₘᵢₙ≤t≤tₘₐₓ (10)

where Fₘₙ^{L} is the flow of a natural-gas pipeline from a node m to a node n, tₘᵢₙ and tₘₐₓ are minimum and maximum linear intervals, respectively, kₘₙ is a slope, and bₘₙ is an intercept.

The slope kₘₙ is expressed by:

kₘₙ=(\sqrt{tₘₐₓ}−\sqrt{tₘᵢₙ})/(tₘₐₓ−tₘᵢₙ) (11)

where tₘᵢₙ is the minimum linear interval, and tₘₐₓ is the maximum linear interval.
The intercept bₘₙ is expressed by:

bₘₙ=(tₘₐₓ\sqrt{tₘᵢₙ}−tₘᵢₙ\sqrt{tₘₐₓ})/(tₘₐₓ−tₘᵢₙ) (12).

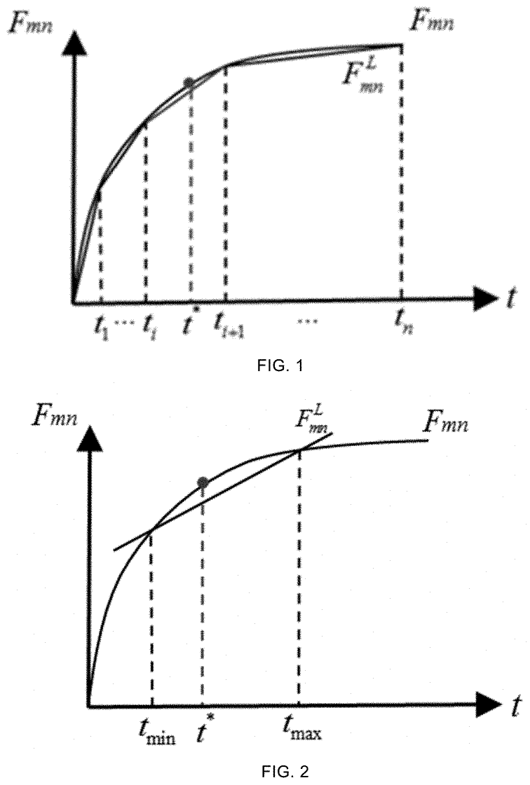

As conventional natural-gas linearization idea, the segmented linearization method shown in FIG. 1 is used. However, since the range of the state variable t is very large, the expected precision of linearization can be achieved generally by division into multiple segments. If it is known in advance which segment of the segmented linear model the optimal solution is located, the segmented linear model can be represented by a one-segment linear model, as shown in FIG. 2. The linearization idea of the present invention is to replace the nonlinear model of the natural-gas with a one-segment linear model. There are two key points to construct the one-segment linear model: 1) finding the approximate position of the optimal solution; and 2) selecting a suitable interval.

3) Based on the linear natural-gas model, a full-linear model for the optimal power flow of the integrated power and natural-gas system is established.

The establishing a full-linear model for the optimal power flow of the integrated power and natural-gas system mainly includes following steps.

3.1) A target function is established, i.e.:

min ƒ=ΣC_{ep,i}P_{G,i}+ΣC_{gp,i}F_{G,m}+ΣM(εᵣ⁻+εᵣ⁺) (13)

where C_{ep,i} is the unit price of power, C_{gp,i} is the unit price of natural-gas, M is a penalty factor, εᵣ⁻ and εᵣ⁺ are balance variables, the subscript r represents the number of natural natural-gas pipelines in the network, min ƒ is a minimum total energy cost, the total energy cost including cost of power and cost of natural-gas, P_{G,i} is an active output of a non-gas generator set, and F_{G,m} is the injection amount from a gas source.
3.2) Constraints are set, mainly including following steps.
3.2.1) Constraints for a power system are set, mainly including an electric power balance constraint, an active power constraint for a gas generator set, an active power constraint for a non-gas generator set and a power transmission line constraint.

The electric power balance constraint is expressed by:

P_{G,i}+P_{GAS,i}−P_{D,i}−(θᵢ−θⱼ)/xᵢⱼ=0,i=1,2, . . . ,Nₑ (14)

where P_{GAS,i} is an active output of the gas generator set, P_{D,i} is an active load, θᵢ is the voltage phase angle of a node i, θⱼ is the voltage phase angle of a node j, xᵢⱼ is the reactance of branches, and Nₑ is the number of nodes in the power system.

The active power constraint for the gas generator set is expressed by:

P_{GAS,i}^{min}≤P_{GAS,i}≤P_{GAS,i}^{max},i=1,2, . . . ,Nₑ (15)

where P_{GAS,i}^{min} is a minimum active output of the gas generator set, and P_{GAS,i}^{max} is a maximum active output of the gas generator set.

The active power constraint for the non-gas generator set is expressed by:

P_{G,i}^{min}≤P_{G,i}≤P_{G,i}^{max},i=1,2, . . . ,Nₑ (16)

where P_{G,i}^{min} is a minimum active output of the non-gas generator set, and P_{G,i}^{max} is a maximum active output of the non-gas generator set.

The power transmission line constraint is expressed by:

−Tₗ^{min}≤B_{ƒ}(θᵢ−θⱼ)≤Tₗ^{max},l=1,2, . . . ,Nᵣ (16)

where B_{ƒ} is a matrix for calculating a transmitted power vector of branches, Tₗ^{min} and Tₗ^{max} are minimum and maximum transmitted power of the branches, respectively, and Nᵣ is the number of branches.
3.2.2) Constraints for a natural-gas system are set, mainly including a gas flow balance constraint, a constraint for the pressure difference t between two ends of the natural-gas pipeline, a gas source constraint, a node pressure constraint and a compressor constraint.
The gas flow balance constraint is expressed by:

F_{G,m}−F_{GAS,m}−F_{D,m}−Fₘₙ^{L}=0,m=1,2, . . . ,Nₘ (18)

where F_{GAS,m} is the consumption of natural-gas by the gas generator set, F_{D,m} is a gas load, and Nₘ is the number of natural-gas nodes.

The pressure difference t between two ends of the natural-gas pipeline is expressed by:

tₘ^{min}−εᵣ⁻≤tₘ≤tₘ^{max}+εᵣ⁺,m=1,2, . . . ,Nₘ (19).

The gas source constraint is expressed by:

F_{G,m}^{min}≤F_{G,m}≤F_{G,m}^{max},m=1,2, . . . ,Nₘ (20)

where F_{G,m}^{min} is a minimum injection amount from the gas source, and F_{G,m}^{max} is a maximum injection amount from the gas source.

The node pressure constraint is expressed by:

πₘ^{min}≤πₘ≤πₘ^{max},m=1,2, . . . ,Nₘ (21)

where πₘ^{min} is a minimum pressure at a node m, and πₘ^{max} is a maximum pressure at the node m.

The compressor constraint is expressed by:

πₙ≤Γ_{c}·πₘ,m=1,2, . . . ,Nₘ (22)

where Γ_{c} is the compression ratio of a compressor.
3.2.3) Constraints for a coupling element are set, i.e.:

F_{GAS,h}=P_{GAS,h}/(η_{GAS,h}GHV),h=1,2, . . . ,N_{b} (23)

where η_{GAS,h} is the conversion efficiency of the gas generator set, GHV is a high heat value, and N_{b} is the number of gas generator sets.

### Embodiment 2

A test for verifying the validity of the linear interval [tₘᵢₙ, tₘₐₓ] is provided, mainly including following steps.

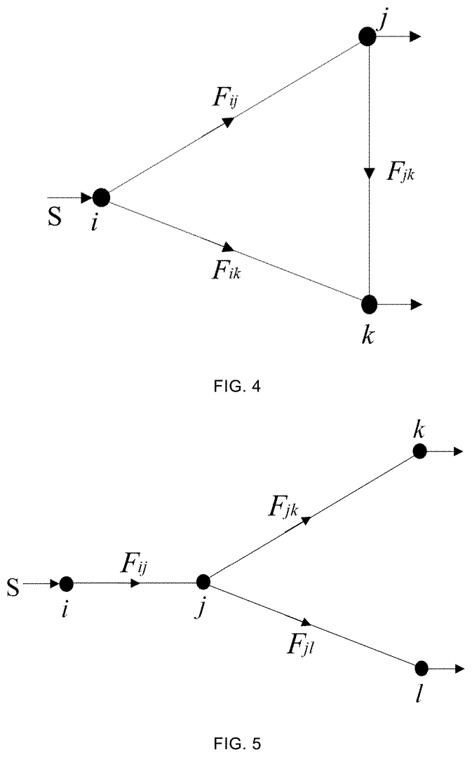

1) The validity of the linear interval [tₘᵢₙ, tₘₐₓ] is verified by a loop natural-gas network. The loop natural-gas network is shown in FIG. 4.
The following three formulae can be obtained based on the formula (3):

tᵢⱼ=(πᵢ²−πⱼ²) (24)

tᵢₖ=(πᵢ²−πₖ²) (25)

tⱼₖ=(πⱼ²−πₖ²) (26).

The relationship among between the natural-gas pipeline pressure difference tᵢⱼ, the natural-gas pipeline pressure difference tᵢₖ and the natural-gas pipeline pressure difference tⱼₖ can be expressed by the following formula (27):

tⱼₖ=tᵢₖ−tᵢⱼ (27).

The formula (7) is substituted into the formula (27), then:

$$\frac{\frac{{F}_{jk}^{L}}{{K}_{jk}} - {b}_{jk}}{{k}_{jk}} = \frac{\frac{{F}_{ik}^{L}}{{K}_{ik}} - {b}_{ik}}{{k}_{ik}} - \frac{\frac{{F}_{ij}^{L}}{{K}_{ij}} - {b}_{ij}}{{k}_{ij}} . \qquad ( 28 )$$

The linear interval is constructed by the formulae (11) and (12), so kₘₙ and bₘₙ can be expressed in the following forms:

kₘₙ=1/\sqrt{t*}(\sqrt{c₂}+\sqrt{c₁}) (29)

bₘₙ=1/\sqrt{t*}(c₂\sqrt{c₁}−c₁\sqrt{c₂})/(c₂−c₁) (30).

The formulae (29) and (30) are substituted into the formula (28), and it is assumed that n=(c₂\sqrt{c₁}−c₁\sqrt{c₂})/(c₂−c₁), so that the following formula (31) can be obtained:

$$\sqrt{{t}_{jk}^{*}} \frac{{F}_{jk}^{L}}{{K}_{jk}} - {t}_{jk}^{*} n = ( \sqrt{{t}_{jk}^{*}} \frac{{F}_{ik}^{L}}{{K}_{ik}} - {t}_{ik}^{*} n ) - ( \sqrt{{t}_{ij}^{*}} \frac{{F}_{ij}^{L}}{{K}_{ij}} - {t}_{ij}^{*} n ) . \qquad ( 31 )$$

It is assumed that all natural-gas pipelines in the network satisfy s>0. When the t* obtained by deep learning and the t in the nonlinear model are identical, the following formula can be obtained:

Fₘₙ=Kₘₙ\sqrt{t*} (32).

Meanwhile, the t* obtained by deep learning also satisfies the following formula:

tⱼₖ^{*}=tᵢₖ^{*}−tᵢⱼ^{*} (33).

The formula (32) is substituted into the formula (31), then:

$${t}_{jk}^{*} \cdot [ \frac{{F}_{jk}^{L}}{{F}_{jk}} - n ] = {t}_{ik}^{*} \cdot [ \frac{{F}_{ik}^{L}}{{F}_{ik}} - n ] - {t}_{ij}^{*} \cdot [ \frac{{F}_{ij}^{L}}{{F}_{ij}} - n ] \qquad ( 34 )$$

Since the formulae (33) and (34) are suitable for all loops in the loop natural-gas network, it can be inferred that the feasible region of the one-segment linear model contains two feasible sub-regions when t* is not equal to 0, as shown below:

$$\{ \begin{matrix}\frac{{F}_{jk}^{L}}{{F}_{jk}} = \frac{{F}_{ik}^{L}}{{F}_{ik}} = \frac{{F}_{ij}^{L}}{{F}_{ij}} = c , \frac{{F}_{jk}^{L}}{{F}_{jk}} = \frac{{F}_{ik}^{L}}{{F}_{ik}} & ( 35 ) \\ \frac{{t}_{ik}^{*}}{{t}_{ij}^{*}} = \frac{\frac{{F}_{jk}^{L}}{{F}_{jk}} - \frac{{F}_{ij ij}^{L}}{{F}_{ij}}}{\frac{{F}_{jk}^{L}}{{F}_{jk}} - \frac{{F}_{ik}^{L}}{{F}_{ik}}} , \frac{{F}_{jk}^{L}}{{F}_{jk}} \neq \frac{{F}_{ik}^{L}}{{F}_{ik}} & ( 36 )\end{matrix}$$

where c is a constant related to the nonlinear and linear natural-gas flow.

It can be easily inferred that the feasible region described by the formula (35) is a sub-region of the original nonlinear OPF in the integrated power and natural-gas system. Therefore, when c=1, the optimal solution appears in the feasible region (35). It is indicated that the optimal solution of the nonlinear model OPF in the integrated power and natural-gas system is located in the feasible region of the OPF having a one-segment linear model. That is, in the feasible sub-region (35), the result of optimization of the nonlinear model OPF is the same as the optimal solution of the OPF having a one-segment linear model.

Therefore, the OPF of the one-segment linear model provided by the present invention generally has the same result of optimization as the nonlinear OPF.

2) The validity of the linear interval [tₘᵢₙ, tₘₐₓ] is verified by a natural-gas tree network. The natural-gas tree network is shown in FIG. 5.
FIG. 5 shows a typical natural-gas tree network which satisfies the following equations:

tᵢⱼ=(πᵢ²−πⱼ²) (37)

tⱼₖ=(πⱼ²−πₖ²) (38)

tⱼₗ=(πⱼ²−πₗ²) (39).

Unlike the loop network, there is no strong coupling relationship among tᵢⱼ, tⱼₖ and tⱼₗ in the tree network. Therefore, during the solution of the optimization, the flow of each pipeline can be optimized independently, without being influenced by other pipelines. Therefore, when the pressure constraint has no constraint force, the linear model will have the same result optimization as the nonlinear model.

### Embodiment 3

A test for verifying the validity of the full-linear model for the optimal power flow of an integrated power and natural-gas system based on a deep learning method is provided, mainly including following steps.

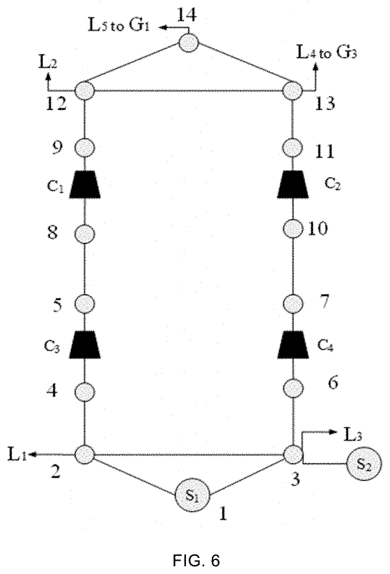

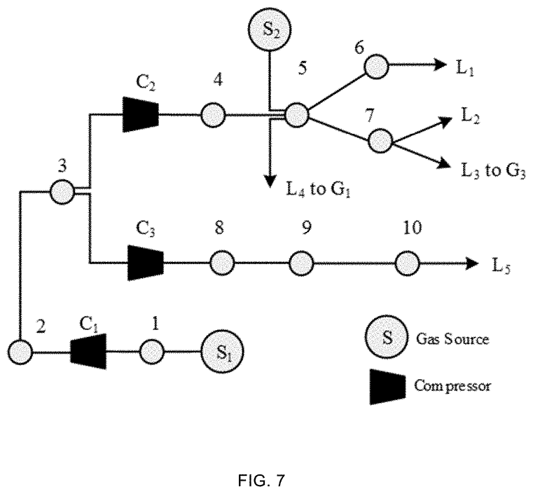

1) A test system is established.
Case 1: The test system consists of an IEEE 14-node network and an NGS 14-node network (the NGS 14-node network contains two gas loops). The network diagram of the NGS 14 nodes is shown in FIG. 6.
Case 2: The test system consists of an IEEE 14-node network and an NGS 10-node network (the NGS 10-node network is a radial tree network). The network diagram of the NGS 10 nodes is shown in FIG. 7.
2) Different comparison models

To verify the validity of the one-segment linear model provided by the present invention, the following three modes are compared:

M0: an original nonlinear integrated power and natural-gas system OPF model;
M1: an integrated power and natural-gas system full-linear OPF model using the one-segment linear model provided by the present invention; and
M2: an integrated power and natural-gas system OPF model using a multi-segment linear method.
3) Example simulation analysis of case 1

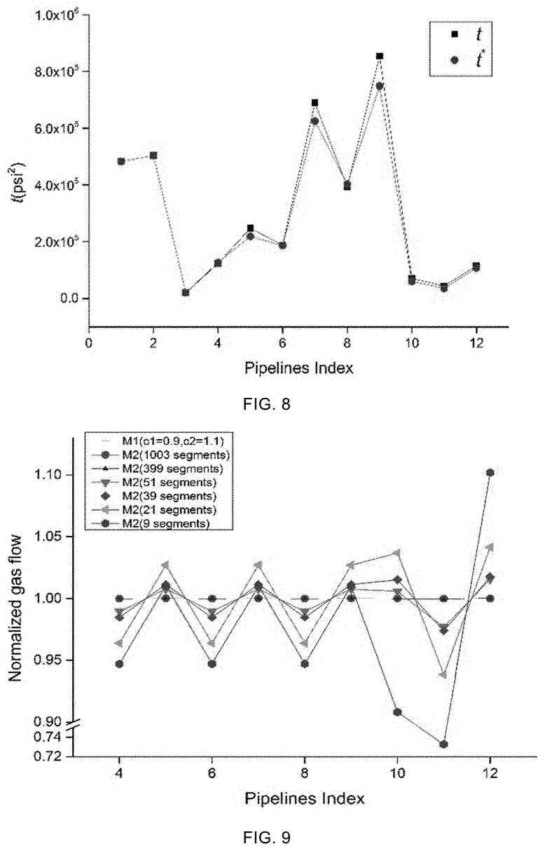

FIG. 8 shows a comparison diagram of the value of t of the original nonlinear OPF and the value of t* predicted by deep learning. It can be observed that the value of t* obtained by deep learning method is close to the value of t of the nonlinear OPF model, but there is still an error. The coupling relationship of the formula (34) is suitable for two loops in the natural-gas network.

Table 1 shows the comparison of the results of optimization in M0 and M1. It can be known from Table 1 that the optimal solution obtained by the method of the present invention is close to the result of optimization of the nonlinear model, and the relative error in the table results from the prediction error of t*. Meanwhile, when the size of the linear interval is changed, the optimal solution obtained by the one-segment linear model is still the same. In addition, when the value of t in the nonlinear model is substituted into the proposed one-segment linear model, the optimal solution of the proposed method is the same as the result of optimization of the nonlinear model. The above theoretical deduction is proved.

TABLE 1
Comparison of M0 and M1 in minimum energy costs

| | Relative error | |
|---|---|---|
| Model | (%) | f (RMB) |
| M0 | — | 6.1362 × e⁴ |
| M1(c₁ = 0.90, c₂ = 1.05) | 0.0181 | 6.1351 × e⁴ |
| M1(c₁ = 0.80, c₂ = 1.10) | 0.0181 | 6.1351 × e⁴ |
| M1(c₁ = 0.70, c₂ = 1.15) | 0.0181 | 6.1351 × e⁴ |
| M1(c₁ = 0.60, c₂ = 1.20) | 0.0181 | 6.1351 × e⁴ |

FIG. 9 shows the normalized natural-gas pipeline flow of the models M1 and M2, where the vertical coordinate represents the gas flow and the horizontal coordinate represents the pipeline. By using the gas flow obtained in the model M0 as reference, the flow of M1 and the flow of M2 are compared. For the model M2, FIG. 9 indicates that the result is closer to the result of the nonlinear model if there are more segments used during the segmented linearization. For the segmented linear model, the modeling precision similar to that of the proposed one-segment linear model can be realized by using a large number of segments.

Table 2 shows the calculation time and the result of optimization of the model 2 under different numbers of segments. It can be observed that, with the increase in the number of segments, the precision of the result of optimization of the OPF will be improved, but the calculation efficiency is reduced. When the segmented linear model is divided into 399 segments, the similar precision is realized by the segmented linear method, when compared to the proposed one-segment linear method. However, since there are no integral variables of the one-segment linear method, the calculation efficiency of the OPF is greatly improved. When c₁=0.8 and c₂=1.1, only 0.23 seconds are required by the proposed one-segment linear method. The speed is increased by 5 times in comparison to the segmented linear model having 399 segments.

TABLE 2
The calculation time and the result of optimization of
the model M2 under different numbers of segments

| The number | The number | | | |
|---|---|---|---|---|
| of | of integral | Calculation | | Relative |
| segments | variables | time (s) | f (RMB) | error (%) |
| 21 | 252 | 0.94 | 6.0831 × e⁴ | 0.8650 |
| 39 | 468 | 0.97 | 6.1133 × e⁴ | 0.3737 |
| 51 | 612 | 0.98 | 6.1204 × e⁴ | 0.2575 |
| 399 | 4788 | 1.34 | 6.1350 × e⁴ | 0.0185 |
| 1003 | 12036 | 3.08 | 6.1351 × e⁴ | 0.0173 |

4) Example simulation analysis of case 2 Table 3 shows the operation cost of the models M0 to M2. The results show that, since the flow of pipelines is not coupled in the natural-gas tree network, the modeling of the linear model will not influence the result of optimization of the OPF of the integrated power and natural-gas system, that is, the result of optimization of the one-segment linear model is the same as that of the nonlinear model; and, if the interval is smaller, the mean square error is smaller. The results prove the above theory.

TABLE 3
The results of optimization and linear errors of M0-M2

| | M1 | | M1 | | | |
|---|---|---|---|---|---|---|
| M0 | c₁ = 0.90, c₂ = 1.15 | | c₁ = 0.90, c₂ = 1.05 | | M2 (21 segments) | |
| ƒ(RMB) | e | ƒ(RMB) | e | ƒ(RMB) | e | ƒ(RMB) |
| 6.0988 × 10⁴ | 2.2255 × e⁴ | 6.0988 × e⁴ | 2.6974 × e³ | 6.0988 × e⁴ | 5.8209 × e⁵ | 6.0988 × e⁴ |

Note:
e is the linear error of the model M0 and the model M1/M2, i.e., the mean square error.

Various embodiments for constructing, based on a deep learning method, a full linear model for optimal power flow of an integrated power and natural-gas system described herein may be implemented in various ways. For example, the they may be implemented by software, hardware, firmware or any combination thereof. The order of the steps of the method described herein is merely for description, and the steps of the method of the present disclosure are not limited to the specific order described above, unless otherwise specified in other ways. In addition, in some embodiments, the present disclosure may also be implemented as programs recoded on a recording medium. These programs include machine-readable instructions for implementing the method of the present disclosure. Therefore, the present disclosure further encompasses the recording medium for storing the programs for implementing the method of the present disclosure.

The descriptions of the present disclosure are merely exemplary and illustrative, but not exhaustive or not intended to limit the present disclosure to the forms disclosed herein. It is apparent for a person of ordinary skill in the art to make various modifications and alterations. The embodiments selected and described herein are merely for better describing the principle and practical applications of the present disclosure, and enable a person of ordinary skilled in the art to understand the present disclosure and design various embodiments with various modifications for a particular purpose.

What is claimed is:

1. A method for constructing, based on a deep learning method, a full linear model for optimal power flow of an integrated power and natural-gas system, wherein the method comprises:
1) establishing the integrated power and natural-gas system, and acquiring basic data of the integrated power and natural-gas system;
2) establishing a linear natural-gas model based on an deep learning method; and
3) based on the linear natural-gas model, establishing a full-linear model for the optimal power flow of the integrated power and natural-gas system.

2. The method according to claim 1, wherein the basic data of the integrated power and natural-gas system is an electrical load and a gas load of the integrated power and natural-gas system.

3. The method according to claim 1, wherein establishing the linear natural-gas model based on the deep learning method comprises:
1) establishing a nonlinear natural-gas flow model using the following formula:
Fₘₙ=sₘₙKₘₙ\sqrt{sₘₙt}
wherein Fₘₙ^{L} is the flow of a natural-gas pipeline from a node m to a node n, Kₘₙ is a Weymouth coefficient for a pipeline in a steady state, sₘₙ is a sign function, and t is a pressure difference between two ends of the natural-gas pipeline;
wherein the value of the sign function sₘₙ is expressed by:
$${s}_{mn} = \{ \begin{matrix}+ 1 & {π}_{m} \geq {π}_{n} \\ - 1 & {π}_{m} < {π}_{n}\end{matrix}$$
wherein πₘ and πₙ are pressures at the node m and the node n, respectively; and
the pressure difference t between two ends of the natural-gas pipeline is expressed by:
t=(πₘ²πₙ²)
2) establishing a deep neural network, i.e., a Stacked Denoising Automatic Encoder (SDAE);
wherein the SDAE is formed by stacking n Denoising Automatic Encoders (DAEs) layer by layer;
wherein, an input layer of the l^{th} DAE is denoted by Yₗ₋₁, an intermediate layer is denoted by Yₗ, and an output layer is denoted by Zₗ;
the intermediate layer Yₗ is expressed by:
Yₗ=ƒ_{θ}^{l}(Yₗ₋₁)=R(WₗYₗ₋₁+bₗ)
wherein ƒ_{θ}^{l}(Yₗ₋₁) represents an encoding function, R is an activation function, θ is an encoding parameter and θ={Wₗ, bₗ}, where Wₗ is the weight of the encoding function, and bₗ is the bias of the encoding function;
the activation function R is expressed by:
$$R ( x ) = \{ \begin{matrix}x & if x > 0 \\ 0 & if x \leq 0\end{matrix}$$
where x is the input of a neuron, i.e., load data of the integrated power and natural-gas system; and
the output layer Zₗ is expressed by:
Zₗ=g_{θ′}^{l}(Yₗ)=R(Wₗ^{′}Yₗ+bₗ^{′})
where g_{θ′}^{l} (Yₗ) represents a decoding function, θ′ is a decoding parameter and θ′={Wₗ^{′}, bₗ^{′}},
where Wₗ^{′} is the weight of the decoding function and bₗ^{′} is the bias of the decoding function;
3) inputting the electrical load and the gas load into the SDAE to obtain an output t;
4) adjusting the output t by unsupervised pre-training and supervised fine-tuning to obtain a predicted result t* of deep learning;
5) based on the predicted result t*, selecting a linear interval [tₘᵢₙ, tₘₐₓ]; and
6) expressing the linear natural-gas model based on deep learning as follows:
Fₘₙ^{L}=Kₘₙ(kₘₙt+bₘₙ),tₘᵢₙ≤t≤tₘₐₓ
wherein FL mn is the flow of the natural-gas pipeline from the node m to the node n, tₘᵢₙ and tₘₐₓ are minimum and maximum linear intervals, kₘₙ is a slope, and bₘₙ is an intercept;
wherein the slope kₘₙ is expressed by:
kₘₙ=(\sqrt{tₘₐₓ}−\sqrt{tₘᵢₙ})/(tₘₐₓ−tₘᵢₙ)
wherein tₘᵢₙ is a minimum linear interval, and tₘₐₓ is a maximum linear interval; and
the intercept bₘₙ is expressed by:
bₘₙ=(tₘₐₓ\sqrt{tₘᵢₙ}−tₘᵢₙ\sqrt{tₘₐₓ})/(tₘₐₓ−tₘᵢₙ)

4. The method according to claim 2, wherein selecting a linear interval [tₘᵢₙ, tₘₐₓ] mainly comprises following steps:
1) calculating the minimum linear interval tₘᵢₙ using the following formula:
tₘᵢₙ=c₁t*
where c₁ is a constant and c₁<1; and
2) calculating the maximum linear interval tₘₐₓ using the following formula:
tₘₐₓ=c₂t*
where c₂ is a constant and c₂>1.

5. The method according to claim 1, wherein establishing the full-linear model for the optimal power flow of the integrated power and natural-gas system mainly comprises following steps:
1) establishing a target function, i.e.:
min ƒ=ΣC_{ep,i}P_{G,i}+ΣC_{gp,i}F_{G,m}+ΣM(εᵣ⁻+εᵣ⁺)
wherein C_{ep,i} is the unit price of power, C_{gp,i} is the unit price of natural-gas, M is a penalty factor, εᵣ⁻ and εᵣ⁺ are balance variables, the subscript r represents the number of natural-gas pipelines in the network, min ƒ is a minimum total energy cost, the total energy cost including cost of power and cost of natural-gas, P_{G,i} is an active output of a non-gas generator set, and F_{G,m} is the injection amount from a gas source;
2) setting constraints, mainly comprising following steps:
2.1) setting constraints for a power system, mainly comprising an electric power balance constraint, an active power constraint for a gas generator set, an active power constraint for a non-gas generator set and a power transmission line constraint;
wherein the electric power balance constraint is expressed by:
P_{G,i}+P_{GAS,i}−P_{D,i}−(θᵢ−θⱼ)/xᵢⱼ=0,i=1,2, . . . ,Nₑ
wherein P_{GAS,i} is the active output of the gas generator set, P_{D,i} is the active load, θᵢ is the voltage phase angle of a node i, θⱼ is the voltage phase angle of a node j, xᵢⱼ is the reactance of branches, and Nₑ is the number of nodes in the power system;
the active power constraint for the gas generator set is expressed by:
P_{GAS,i}^{min}≤P_{GAS,i}≤P_{GAS,i}^{max},i=1,2, . . . ,Nₑ
wherein P_{GAS,i}^{min} is a minimum active output of the gas generator set, and P_{GAS,i}^{max} is a maximum active output of the gas generator set;
the active power constraint for the non-gas generator set is expressed by:
P_{G,i}^{min}≤P_{G,i}≤P_{G,i}^{max},i=1,2, . . . ,Nₑ
wherein P_{G,i}^{min} is a minimum active output of the non-gas generator set, and P_{G,i}^{max} is a maximum active output of the non-gas generator set; and
the power transmission line constraint is expressed by:
−Tₗ^{min}≤B_{ƒ}(θᵢ−θⱼ)≤Tₗ^{max},l=1,2, . . . ,Nᵣ
wherein B_{ƒ} is a matrix for calculating a transmitted power vector of branches, Tₗ^{min} and Tₗ^{max} are minimum and maximum transmitted power of the branches, respectively, and Nᵣ is the number of branches;
2.2) setting constraints for a natural-gas system, mainly comprising a natural-gas flow balance constraint, a constraint for the pressure difference t between two ends of the natural-gas pipeline, a gas source constraint, a node pressure constraint and a compressor constraint;
wherein the gas flow balance constraint is expressed by:
F_{G,m}−F_{GAS,m}−F_{D,m}−Fₘₙ^{L}=0,m=1,2, . . . ,Nₘ
where F_{GAS,m} is the consumption of natural-gas by the gas generator set, F_{D,m} is a gas load and Nₘ is the number of natural-gas nodes;
the pressure difference t between two ends of the natural-gas pipeline is expressed by:
tₘ^{min}−εᵣ⁻≤tₘ≤tₘ^{max}+εᵣ⁺,m=1,2, . . . ,Nₘ
the gas source constraint is expressed by:
F_{G,m}^{min}≤F_{G,m}≤F_{G,m}^{max},m=1,2, . . . ,Nₘ
where F_{G,m}^{min} is a minimum injection amount from the gas source, and F_{G,m}^{max} is a maximum injection amount from the gas source;
the node pressure constraint is expressed by:
πₘ^{min}≤πₘ≤πₘ^{max},m=1,2, . . . ,Nₘ
where πₘ^{min} is a minimum pressure at a node m, and πₘ^{max} is a maximum pressure at the node m; and
the compressor constraint is expressed by:
πₙ≤Γ_{c}·πₘ,m=1,2, . . . ,Nₘ
where Γ_{c} is the compression ratio of a compressor; and
2.3) setting constraints for a coupling element, i.e.:
F_{GAS,h}=P_{GAS,h}/(η_{GAS,h}GHV),h=1,2, . . . ,N_{b}
where η_{GAS,h} is the conversion efficiency of the gas generator set, GHV is a high heat value, and N_{b} is the number of gas generator sets.
